(19) United States
(12) Patent Application Publication
(10) Pub. No.: US 2007/0118288 A1
(43) Pub. Date: May 24, 2007

(54) Travel device

(75) Inventors: Takao Tani, Osaka (JP); Naoya Uehigashi, Osaka (JP); Ryo Saeki, Osaka (JP); Akitaka Shimizu, Osaka (JP)

Correspondence Address: Yokoi & Co., U.S.A., Inc., 13700 Marina Pointe Drive #723, Marina Del Rey, CA, 90292, US

(73) Assignee: Funai Electric Co., Ltd., Osaka (JP)

(21) Appl. No.: 11/603,364

(22) Filed: Nov. 21, 2006

(30) Foreign Application Priority Data
Nov. 24, 2005 (JP) JP2005-339524

(51) Int. Cl. G05D 1/00

(52) U.S. Cl. 701/301; 701/23

(57) ABSTRACT

In a self-propelled cleaner 10, after distance data from an ultrasonic ranging-sensor 31 is obtained, a judgment is made as to whether the distance data is below an approaching limit value. If the distance data is below the approaching limit value, travel of a body is stopped. If the distance data is not the approaching limit value, distance data from light ranging-sensors 32R, 32L are obtained. If distance data is below the approaching limit value, and the travel of the body is stopped, so that even if a target is a target which can not be subjected to precise ranging by the ultrasonic ranging-sensor only, it can be subjected to the precise ranging by using the light ranging-sensors. Thus it is possible to increase the number of targets capable of being subjected to the precise ranging and prevent the body from colliding against the obstacle.

### CROSS-REFERENCES TO RELATED APPLICATIONS

The present application is related to the Japanese Patent Application No. 2005-339524, filed Nov. 24, 2005, the entire disclosure of which is expressly incorporated by reference herein.

### BACKGROUND OF THE INVENTION

(1.) Field of the Invention

The present invention relates to a travel device (such as a self-propelled cleaner) which is adapted to be traveled on a floor surface of a predetermined range, on the basis of a predetermined control program memorized in advance.

(2.) Description of the Related Art

Hitherto, as this type of self-propelled cleaner, there is known a self-propelled cleaner which is disclosed in Japanese Patent Application Laid-Open No. 2002-533797.

The self-propelled cleaner disclosed in the Japanese Patent Unexamined Application Publication has a body, four pairs of light ranging-sensors arranged at a front surface of the body, and two pairs of ultrasonic ranging-sensors arranged at the left and right of the front surface of the body. The light ranging-sensors and the ultrasonic ranging-sensors have individual functions and are adapted to obtain information on circumstances around the body.

In the conventional self-propelled cleaner, there are the following problems to be solved.

In a case where any obstacle ahead of the body is detected by the ultrasonic ranging-sensors, if the obstacle is a soft object, distances between the obstacle and the body which are detected by the ultrasonic ranging-sensors are not uniform, thus making it impossible to grasp an exact distance between the obstacle and the body.

On the other hand, in a case where the obstacle ahead of the body is detected by the light ranging-sensors, if the obstacle is an object having such a color as to be difficult to reflect light, for example, a blackish object, there is a possibility that the light ranging-sensors will be unable to detect the obstacle.

Therefore, when the self-propelled cleaner is provided with either the ultrasonic ranging-sensors or the light ranging-sensors, or when the self-propelled cleaner is provided with both the ultrasonic ranging-sensors and the light ranging-sensors but the obstacle ahead of the body is detected by either the ultrasonic ranging-sensors or the light ranging-sensors, it is impossible to detect all obstacles around the body in order that the body can be traveled while being precisely kept away from the obstacles.

### BRIEF SUMMARY OF THE INVENTION

The present invention discloses a travel device that can fulfill the function of positively keeping a body away from walls of the interior of a room and obstacles on a floor of the room, without allowing the body to collide against the walls and the obstacles, even if the walls and the obstacles have any color, and that can precisely cause the body to be kept at an angle perpendicular to a wall of the room which is located ahead of the body.

One aspect of the present invention provides a travel device comprising: a body; a driving mechanism for causing the body to be traveled in a predetermined direction; a movement-detecting sensor for detecting information on the movement of the body; a peripheral sensor for detecting circumstances around the body; an operation panel arranged at an outer surface of the body; and a control section for receiving detection results obtained by the movement-detecting sensor and the peripheral sensor, and an operation input from the operation panel, controlling the driving mechanism according to predetermined control programs memorized in advance, causing the body to be traveled on a floor surface of a predetermined range; the peripheral sensor comprising: light ranging-sensors arranged at a front side of the body; an ultrasonic ranging-sensor arranged at the front side of the body; and sidewall sensors arranged at the left and right of the body; the control section being adapted to carry out a mapping operation with respect to a room interior or the like on the basis of a dimension of the body, while causing the body to be traveled a predetermined range of the room interior by the driving mechanism, recognize information on locations of the body in the room interior, according to operation instructions from the operation panel; the control section being adapted to cause the sidewall sensors to detect any obstacles on sides of the body and cause both the ultrasonic ranging-sensor and the light ranging-sensors to detect any obstacle ahead of the body, while causing the body to be traveled by the driving mechanism, when the mapping operation is carried out; the control section being adapted to control the driving mechanism in such a manner that the driving mechanism does not allow the body to collide against the obstacles and keeps the body away from the obstacles when the obstacles are detected; and the control section being adapted to cause detection results of the peripheral sensor and information on the movement of the body to be reflected in mapping data.

In the travel device constructed as discussed above, the control section receives the detection results obtained by the movement-detecting sensor and the peripheral sensor, and the operation input from the operation panel, controls the driving mechanism according to the predetermined control programs memorized in advance, causes the body to be traveled on the floor surface of the predetermined range. When the driving mechanism causes the body to be traveled the predetermined range of the room interior, the control section is adapted to carry out the mapping operation with respect to the room interior or the like on the basis of the dimension of the body, while always recognizing the information on the locations of the body in the room interior.

Moreover, the control section is adapted to cause the sidewall sensors to detect the obstacles on sides of the body and cause both the ultrasonic ranging-sensor and the light ranging-sensors to detect the obstacle ahead of the body, while causing the body to be traveled by the driving mechanism, when the mapping operation is carried out, adapted to control the driving mechanism in such a manner that the driving mechanism does not allow the body to collide against the obstacles and keeps the body away from the obstacles when the obstacles are detected; and adapted to cause the detection results of the peripheral sensor and the information on the movement of the body to be reflected in the mapping data.

An optional aspect of the present invention provides a travel device, wherein the control section is adapt to cause the ultrasonic ranging-sensor to detect the obstacle ahead of the body, while causing the body to be traveled, adapted to control the driving mechanism in such a manner that the driving mechanism does not allow the body to collide against the obstacle ahead of the body and keeps the body away from the obstacles ahead of the body when the obstacle is detected by the ultrasonic ranging-sensor, adapted to cause the light ranging-sensors to detect the obstacle ahead of the body when the obstacle ahead of the body is not detected by the ultrasonic ranging-sensor, and adapted to control the driving mechanism in such a manner that the driving mechanism does not allow the body to collide against the obstacle ahead of the body and keeps the body away from the obstacle ahead of the body when the obstacle ahead of the body is detected by the light ranging-sensors.

In the travel device constructed as discussed above, first of all the ultrasonic ranging-sensor detects the obstacle ahead of the body and, unless the obstacle ahead of the body is detected by the ultrasonic ranging-sensor, the light ranging-sensors detect the obstacle ahead of the body. When the obstacle ahead of the body is detected by either of the ultrasonic ranging-sensor and the light ranging-sensors, the driving mechanism causes the body to be kept away from the obstacle ahead of the body so as not to collide against the obstacle ahead of the body.

Another optional aspect of the present invention provides a travel device, wherein the light ranging-sensors are arranged at the left and right of the front side of the body, and the ultrasonic ranging-sensor is arranged at a substantially central portion of the front side of the body

The light ranging-sensors are very accurate in detection except detection of obstacles difficult to be detected. The light ranging-sensors are arranged at the left and right of the front side of the body, so that when the body faces an obstacle such as the wall of the room interior, the light ranging-sensors each can precisely measure a distance between the body and the obstacle and also detect an angle of the body relative to the obstacle. Moreover, the ultrasonic sensor which is inferior to the light ranging-sensors in sensing-precision is arranged at the substantially central portion of the front side of the body, so that the structure of the ultrasonic sensor is limited to the irreducible minimum of a demand.

Another optional aspect of the present invention provides a travel device, wherein the control section may be designed such that it controls the driving mechanism in such a manner that the driving mechanism causes the body to be turned in such a manner to allow detection results of the light ranging-sensors to coincide with each other, causes a travel angle of the body to be changed, and corrects the travel angle of the body in such a manner that the body becomes perpendicular to the obstacle ahead of the body, when the obstacle ahead of the body is detected and the detection results of the light ranging-sensors are obtained.

In the travel device constructed as discussed above, when the obstacle ahead of the body is detected and the detection results of the light ranging-sensors are obtained, it is possible to detect an angle of the body relative to the obstacle on the basis of the detection results of the light ranging-sensors. Therefore, the control section controls the driving mechanism in such a manner that the driving mechanism causes the body to be turned in such a manner that the detection results of the light ranging-sensors coincide with each other, changes the travel direction of the body and causes the travel direction of the body to be corrected in such a manner that the body becomes perpendicular to the obstacle ahead of the body.

Another optional aspect of the present invention provides a travel device, wherein the control section may be designed such that it controls the driving mechanism in such a manner that the driving mechanism causes the travel angle of the body to be changed in such a manner that the detection results of the ultrasonic ranging-sensor become minimum, while causing the body to be turned, whereby the travel angle of the body is corrected in such a manner that the body becomes perpendicular to the obstacle ahead of the body, when the obstacle ahead of the body is detected and the detection results of the light ranging-sensors are not obtained.

In the travel device constructed as discussed above, even if the detection results of the light ranging-sensors are not obtained when the obstacle ahead of the body, the control section controls the driving mechanism in such a manner that it causes the body to be turned, whereby the angle of the body relative to the obstacle ahead of the body can be also detected on the basis of the detection results of the ultrasonic ranging-sensor. Therefore, the control section controls the driving mechanism in such a manner that the driving mechanism causes the travel angle of the body to be changed in such a manner that the detection results of the ultrasonic ranging-sensor become minimum, whereby the travel angle of the body is corrected in such a manner that the body becomes perpendicular to the obstacle ahead of the body.

Another aspect of the present invention provide a travel device comprising: a body having a substantially cylindrical shape that is short in length; a driving mechanism for causing the body to be traveled in a predetermined direction; a movement-detecting sensor for detecting information on the movement of the body; a peripheral sensor for detecting circumstances around the body; an operation panel arranged at an outer surface of the body; and a control section for receiving detection results obtained by the movement-detecting sensor and the peripheral sensor, and an operation input from the operation panel, controlling the driving mechanism according to predetermined control programs memorized in advance, causing the body to be traveled on a floor surface of a predetermined range; the driving mechanism comprising: left and right drive wheels arranged at portions of a bottom of the body which are adjacent to both sides of the bottom of the body; drive motors adapted to be rotated in a normal direction or a reverse direction independently from each other, the left and right drive wheels being adapted to be driven by the drive motors; and a freely rollable wheel provided at a forward portion of the bottom of the body; the movement-detecting sensor being adapted to detect rotation amounts and rotational directions of the left and right drive wheels; the peripheral sensor comprising: light ranging-sensors arranged at the left and right of a front side of the body; an ultrasonic ranging-sensor arranged at a substantially central portion of the front side of the body; and sidewall sensors arranged at the left and right of the body; the control section being adapted to carry out a mapping operation with respect to a room interior or the like on the basis of a dimension of the body, while causing the body to be traveled a predetermined range of the room interior by the driving mechanism, recognize information on locations of the body in the room interior, according to operation instructions from the operation panel; the control section being adapted to cause the sidewall sensors to detect any obstacles on sides of the body and cause the ultrasonic ranging-sensor to detect any obstacle ahead of the body, while causing the body to be traveled, when the mapping operation is carried out; the control section being adapted to control the driving mechanism in such a manner that the driving mechanism does not allow the body to collide against the obstacles and keeps the body away from the obstacles when the obstacles are detected; the control section being adapted to cause the light ranging-sensors to detect the obstacle ahead of the body when the ultrasonic ranging-sensor do not detect the obstacle ahead of the body; the control section being adapted to control the driving mechanism in such a manner that the driving mechanism does not allow the body to collide against the obstacle ahead of the body and keeps the body away from the obstacle ahead of the body when the obstacle ahead of the body is detected by the light ranging-sensors; the control section being adapted to control the driving mechanism in such a manner that the driving mechanism corrects a travel angle of the body so as to cause the body become perpendicular to the obstacle ahead of the body, when the obstacle ahead of the body is detected by the light ranging-sensors, on the basis of detection results of the light ranging-sensors if the detection results are obtained, or detection results of the ultrasonic ranging-sensor unless the detection results of the light ranging-sensors are obtained; and the control section being adapted to cause detection results of the peripheral sensor and information on the movement of the body to be reflected in mapping data.

The way to avoid the obstacle in such a manner as discussed above is not necessarily applied to a tangible device only and can be regarded as a method for avoiding the obstacle.

Incidentally, such an avoiding method can be realized in various manners and can be suitably changed by realizing it in software or hardware.

When as an embodiment of the invention, software is employed, the invention lies in storage medium storing the software and the avoiding method can be used.

Of course, the storage medium may be magnetic recording medium or magneto-optical storage medium. Any storage medium which will be developed in the future may be employed. Moreover, the course of reproductions such as a primary reproduced-product and a secondary reproduced-product do not become problems. In addition, even if a supply manner utilizing a communication channel is employed as a supply manner, as a matter of course, the present invention can be applied to this case

Moreover, even if one of elements of the invention is realized by software and one of the elements of the invention is realized by hardware, the technical ideas of the present invention are not varied. One of the elements of the invention may be stored in storage medium and suitably read in as required.

When the present invention is realized in software, it is possible to use the hardware or operating system or it is possible apply the invention independently from the hardware and the operating system. For example, even if various arithmetic operations are employed, the arithmetic operations can be carried out by calling a predetermined function in the operating system or by receiving the function from the hardware without calling the function. In fact, even if the present invention is realized under operation system intervention, a program is recorded in a medium. It is understood that the present invention can be realized by the program only in the course of distribution of the medium.

Moreover, when the present invention is applied to software, as a matter of course, the invention is not only realized as a medium storing a program but is also realized as the program itself, and the program is included in the scope of the present invention

As discussed above, according to the present invention, there is provided a travel device which can be positively kept away from obstacles, regardless of sorts of the obstacles.

Moreover, in the optional aspect of the present invention, first of all, an obstacle is detected by the ultrasonic ranging-sensor which is difficult to detect a soft obstacle only. Should the obstacle be detected, an obstacle against which the travel device may collide is the soft obstacle only. Thus, it is possible to reduce the number of obstacles against which the travel device may collide.

Moreover, in the optional aspect of the present invention, resources for the light ranging-sensors and the ultrasonic ranging-sensor can be restricted to a minimum, thus making it possible to efficiently use the ultrasonic ranging-sensor and the light ranging-sensors.

Moreover, in the optional aspect of the present invention, the light ranging-sensors which are superior in detection-accuracy are employed, so that the angle of the body relative to the wall ahead of the body can be precisely kept so as to be perpendicular to the wall by using the light ranging-sensors.

Moreover, in the optional aspect of the present invention, even if the light ranging-sensors can not be used, the angle of the body relative to the wall ahead of the body can be precisely kept so as to be perpendicular to the wall.

These and other features, aspects, and advantages of the invention will be apparent to those skilled in the art from the following detailed description of preferred non-limiting exemplary embodiments, taken together with the drawings and the claims that follow.

### DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding parts throughout:

FIG. 1 is an exemplary illustration of a schematic perspective view of a body of a self-propelled cleaner according to an embodiment of the present invention;

FIG. 2 is an exemplary illustration of a schematic bottom plan view of the body;

FIG. 3 is an exemplary illustration of a block diagram of an internal structure of the self-propelled cleaner according to-the embodiment of the present invention;

FIG. 4 is an exemplary illustration of a flowchart exhibiting a procedure for a mapping operation of the self-propelled cleaner according to the embodiment of the present invention;

FIG. 5 is an exemplary illustration of a schematic view of the interior of a room to be cleaned with the self-propelled cleaner, which is of assistance in explaining a travel condition of the body at the time of performing the mapping operation;

FIG. 6 is an exemplary illustration a view which is of assistance in explaining the mapping operation; and

FIG. 7 is an exemplary illustration a flowchart exhibiting a procedure for an obstacle-detecting operation of the self-propelled cleaner according to the embodiment of the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

(1) Appearance of a self-propelled cleaner:

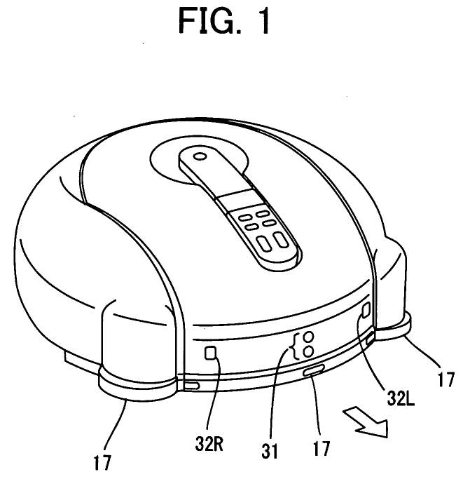

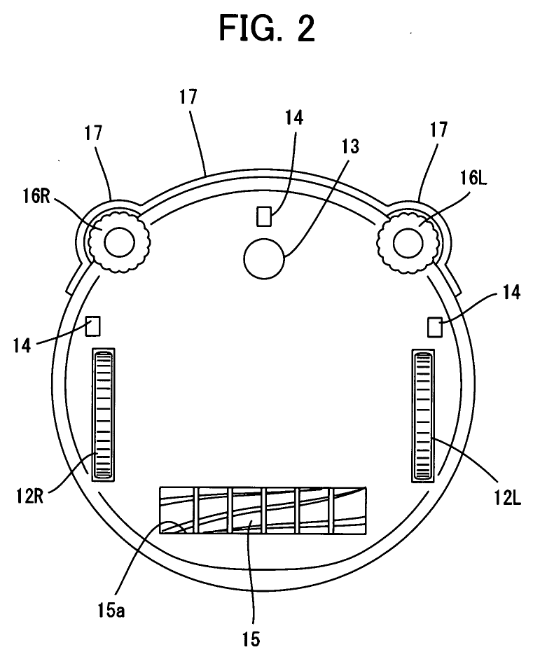

FIG. 1 is a schematic perspective view of a self-propelled cleaner according to an embodiment of the present invention. FIG. 2 is a schematic bottom plan view of the self-propelled cleaner shown in FIG. 1. Incidentally, a direction indicated in FIG. 1 by an arrow corresponds to a basic travel direction of the self-propelled cleaner and a deviation from the travel direction is regarded as a travel angle. As shown in FIG. 1, the self-propelled cleaner 10 according to the present invention has a substantially cylindrical body BD which is short in length. The body BD has two drive wheels 12R, 12L (see FIG. 2) provided at a bottom thereof. The drive wheels 12R, 12L are driven apart from each other, whereby the body BD can be advanced, backed and turned.

An ultrasonic ranging-sensor 31 for measuring a distance is arranged at a central portion of a front side of the body BD. The ultrasonic ranging-sensor 31 comprises an ultrasonic transmitting section for generating supersonic waves and an ultrasonic receiver section for receiving the supersonic waves. The ultrasonic ranging-sensor 31 is designed so that it can detect any obstacle ahead of the body (if any) by receiving, through the ultrasonic receiver section, the supersonic waves which are transmitted from the ultrasonic transmitting section and then reflected from the obstacle, and that it can calculate (measure) a distance from the body BD to a wall of the interior of a room to be cleaned by the self-propelled cleaner, on the basis of time that is required for the ultrasonic receiver section to receive the supersonic waves emitted from the ultrasonic transmitting section.

Moreover, light ranging-sensors 32L, 32R for measuring distances are arranged at the left and right of the front side of the body BD. Each of the light ranging-sensor comprises a light emitting section for emitting infrared rays and a light receiver section for receiving the infrared rays. The light ranging-sensor is designed so that it can detect the obstacle ahead of the self-propelled cleaner by receiving, through the light receiver section, the infrared rays which are emitted from the light emitting section and then reflected from the obstacle, and that it can calculate (measure) a distance from the body BD to the wall on the basis of the intensity of the infrared rays received by the light receiver section.

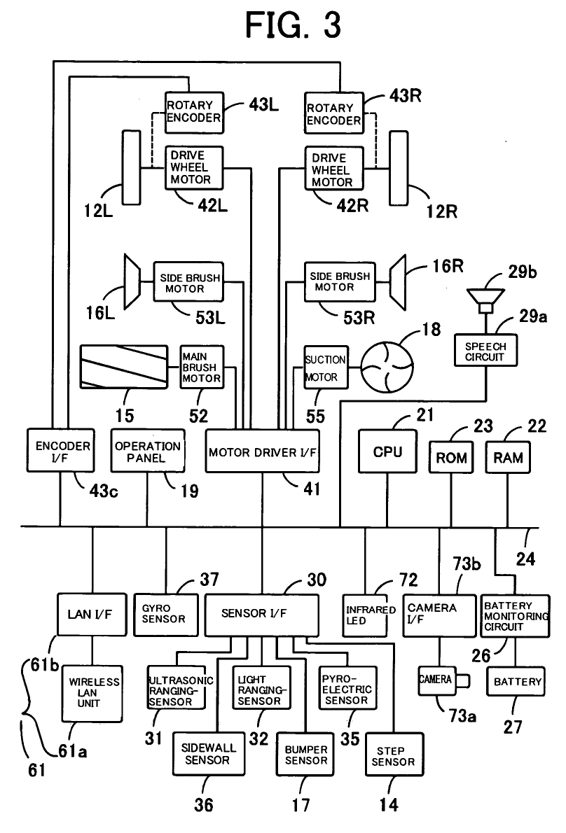

Referring to FIG. 2, the two drive wheels 12R, 12L are arranged at the left and right of a central portion of the bottom of the body BD (adjacent to both sides of the bottom of the body). Moreover, a freely rollable supplementary-wheel (rolling wheel) 13 is provided at a forward portion of the bottom of the body BD (on the side of the travel direction). In addition, step sensors 14 for sensing irregular and step portions of a floor surface of the interior of the room are provided at the bottom of the body BD. Moreover, a main brush 15 is provided at a portion of the bottom of the body BD which is adjacent to a rear portion of the body BD. The main brush 15 is adapted to be rotation-driven by a main brush motor 52 (FIG. 3) and can sweep dirt and/or dust on the floor surface. An opening of a portion of the body BD in which the main brush 15 is mounted is a suction inlet 15a. The dirt and/or dust is adapted to be sucked into the suction inlet 15a while being swept by the main brush 15. Moreover, side brushes 16R, 16L are provided at the left and right of the forward portion of the bottom of the body BD. A bumper sensor 17 is provided at a lower portion of the body BD so as to extend from the front side of the body BD to the both sides of the body BD. The bumper sensor 17 is slightly projected outwardly from the body BD and constitutes a switch which is designed so that, when it is abutted against obstacles around the body BD and then subjected to pushing forces by the obstacles, a contact thereof is closed.

Incidentally, the self-propelled cleaner 10 according to the present invention further includes other various sensors in addition to the ultrasonic ranging-sensor 31, the light ranging-sensors 32L, 32R, the step sensors 14 and the bumper sensor 17 which are shown in FIGS. 1 and 2. The various sensors will be discussed hereinafter with reference to FIG. 3.

(2) Internal structure of the self-propelled cleaner:

FIG. 3 is a block diagram illustrating a structure of the self-propelled cleaner shown in FIGS. 1 and 2. In the illustrated example, a CPU 21, a ROM 23 and a RAM (memory region) 22 which serve as a control section are coupled to the body BD through a bus 24. The CPU 21 is designed so as to use the RAM 22 as a work area and carry out various controls, according to control programs and various parameter tables which are previously stored in the ROM 23.

The body BD is provided with a battery 27. The CPU 21 is designed so as to be able to monitor a residual quantity of the battery 27 through a battery monitoring circuit 26. The battery 27 is provided with a charging terminal that is to be used for charging of the battery 27 by an external charger device. The charging terminal is operatively connected to an electrical supply terminal of the charger device, whereby the charging is carried out. The battery monitoring circuit 26 mainly monitors a voltage of the battery and then detects the residual quantity of the battery 27. Moreover, the body BD has a speech circuit 29a that is coupled to the bus 24. A speaker 29b generates voice according to speech signals that are produced in the speech circuit 29a.

As discussed above, the body BD is provided with the ultrasonic ranging-sensor 31 and the light ranging-sensors 32L, 32R which serve as distance measuring devices, the step sensors 14 and the bumper sensor 17 (see FIGS. 1 and 2). The body BD is further provided with pyroelectric sensors 35 serving as human body sensors for sensing the human body, and sidewall sensors 36L, 36R for detecting sidewalls of the room, as some of the other sensors that are not shown in FIGS. 1 and 2. The pyroelectric sensors 35 are adapted to receive infrared rays emitted from the human body as the human moves, and then detect the human on the basis of variations in the amount of the infrared rays, and are arranged so as to have a sensing range of 360 degrees around the body BD. Like the light ranging-sensors 32L, 32R, the sidewall sensors 36L, 36R are infrared sensors which make use of infrared rays and comprise infrared ray emitting sections and infrared ray receiver sections. As the sidewall sensors 36, there may be employed, for example, passive sensors, ultrasonic ranging-sensors or the like. In the illustrated example, these sensors are coupled to the bus 24 through a sensor I/F 30 and the CPU 21 is adapted to be able to obtain detection results obtained by the sensors.

Moreover, the body BD is provided with a gyro sensor 37 as one of the above-mentioned other sensors. The gyro sensor 37 comprises an angular velocity sensor for detecting a change in an angular velocity due to change in the travel angle of the body BD. The CPU 21 is adapted to be able to detect an angle of a direction in which the body BD is traveled, by carrying out multiplying of a sensor output value detected by the angular velocity sensor.

Moreover, an operation panel 19 is connected to the bus 24. A user can input instructions by operating the operation panel 19. Such an inputting operation is referred to as “operation inputting”.

The self-propelled cleaner 10 according to the present invention is further provided with a motor driver I/F 41, drive wheel motors 42R, 42L and an unshown gear unit arranged between the drive wheel motors 42R, 42L and the above-mentioned drive wheels 12R, 12L, as a driving mechanism for the body BD. The drive wheel motors 42R, 42L are adapted to receive from the motor driver I/F 41 drive signals representing rotational directions and rotation angles and are subjected to particular drive controls. Incidentally, when the body BD is to be advanced, the drive wheel motors 42R, 42L shall be rotated in a normal direction and, when the body BD is to be backed, the drive wheel motors 42R, 42L shall be rotated in a reverse direction. When the body BD is to be turned, the drive wheel motors 42R, 42L are driven so as to differ from each other in the rotational direction and the rotation angle, whereby the body can be randomly turned. The motor driver I/F 41 is adapted to receive control instructions from the CPU 21 and output corresponding drive signals according to the control instructions. Incidentally, as the gear unit and the drive wheels 12R, 12L, there may be employed various gear units and drive wheels. For example, the driving of the body BD may be realized by causing round-shaped rubber tires to be driven or causing endless belts to be traveled.

Moreover, the CPU 21 is adapted to obtain, through an encoder I/F 43c, outputs of rotary encoders 43R, 43L integrally mounted to the drive wheel motors 42R, 42L and adapted to be able to precisely detect actual rotational directions and rotation angles of the drive wheels 12R, 12L. Incidentally, the rotary encoders 43R, 43L may not be mounted directly to the drive wheel motors 42R, 42L and freely rotatable driven wheels may be provided in the vicinity of the drive wheels 12R, 12L. In this case, rotation amounts of the driven wheels are fed back, whereby actual rotation amounts of the drive wheels can be detected even if slipping of the drive wheels occurs. Incidentally, the encoder I/F 43c and the rotary encoders 43R, 43L constitute a movement-detecting sensor of the illustrated embodiment.

A cleaner mechanism of the self-propelled cleaner 10 according to the embodiment of the present invention comprises the two side brushes 16R, 16L provided at the left and right of the bottom of the body BD (see FIG. 2), the main brush 15 provided at the portion of the bottom of the body BD which is adjacent to the rear portion of the body BD (see FIG. 2), and a suction fan 18 (see FIG. 3) for sucking the dirt and/or dust swept by the main brush 15 and facilitating storing of the dirt and/or dust in a dust box (not shown). The main brush 15 is adapted to be driven by the main brush motor 51. Also, the side brushes 16R, 16L are adapted to be driven by side brush motors 53R, 53L. The suction fan 18 is adapted to be driven by a suction motor 55.

The side brushes 16R, 16L are rotation brushes which have rotating shafts and are arranged in pairs at the left and right of the forward portion of the bottom of the body BD in such a manner that the rotating shafts become substantially perpendicular to the floor surface of the room when the body BD is placed on the floor surface. The side brushes 16R, 16L are adapted to be rotation-driven by the side brush motors 53R, 53L so as to be rotated in the directions opposite to each other, whereby the dirt and/or dust on the floor surface is scraped together toward a portion of the floor surface which positionally corresponds to a location below the central portion of the bottom of the body BD. The side brushes 16R, 16L constitute a side brush means of the self-propelled cleaner according to the present invention. The main brush 15 is a roller-shaped rotation brush which has a rotating shaft and is arranged at a rearward portion of the bottom of the body BD in such a manner that the rotating shaft of the main brush 15 becomes substantially horizontal and perpendicular relative to the travel direction of the body BD. The main brush 15 constitutes a main brush means of the self-propelled cleaner which is rotation-driven by the main brush motor 52 and then scoops up the dirt and/or dust on the floor surface. The suction fan 18 is driven by the suction motor 55, whereby the scooped-up dirt and/or dust is sucked into the dust box through the suction inlet 15a (FIG. 2) and stored in the dust box. Thus, the suction fan 18, the suction motor 55 and the suction inlet 15a constitute a suction means of the self-propelled cleaner.

The motor driver I/F 41 is adapted to supply driving power to the main brush motor 52, the side brush motors 53R, 53L and the suction motor 55. The cleaning performed by the cleaner mechanism is suitably judged by the CPU 21, depending upon a condition of the floor surface, a condition of the battery and the instructions from the user. The CPU 21 is adapted to cause the motor driver I/F 41 to supply the driving power to the main brush motor 52, the side brush motors 53R, 53L and the suction motor 55, and control them.

The body BD further includes a wireless LAN module means 61 which comprises a wireless LAN unit 61a and a LAN I/F 61b. The CPU 21 is adapted to be able to communicate with an external LAN by radio according to a predetermined protocol. On the condition that there are unshown access points, the wireless LAN module means 61 shall be governed by an environment in which the access points are connectable to an external wideband net work (for example, Internet) through routers or the like. Therefore, it is possible to carry out transmit-receive of usual mails through the Internet and reading of web sites. Incidentally, the wireless LAN module means 61 further includes a standardized card slot, a standardized wireless LAN card which is connected to the slot, and the like. Of course, a different standardized card may be connected to the card slot.

The body BD is further provided with an infrared CCD camera 73a, a camera I/F 73b and an infrared ray source 72. An image picking-up signal which is generated in the infrared CCD camera 73a is transmitted through the camera I/F 73b and the bus 24 to the CPU 21 which carries out various processes with respect to the image picking-up signal. The infrared CCD camera 73a has an optical system that can pick up an image of an area in front of the body BD, and produces an electric signal according to infrared rays that are incident on a filed of view that is realized by the optical system. Concretely, there are provided a plurality of cells that are arranged correspondingly to respective picture elements at an image formation location that is determined by the optical system. The respective cells produce electric signals which correspond to the amount of the incident infrared rays. A CCD element temporarily memorizes the electric signals that are produced for every picture elements, and produces image picking-up signals in which the electric signals are continued for the respective picture elements. Then, the produced image picking-up signals are suitably outputted to the CPU 21.

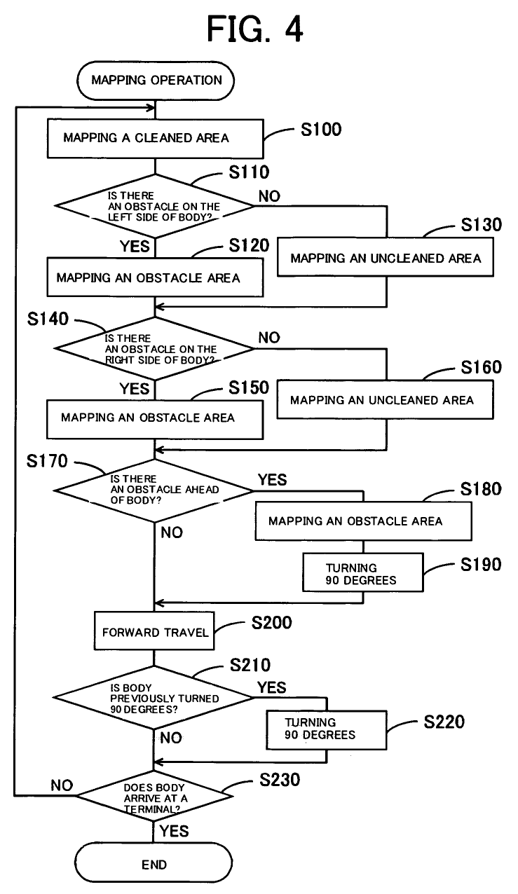

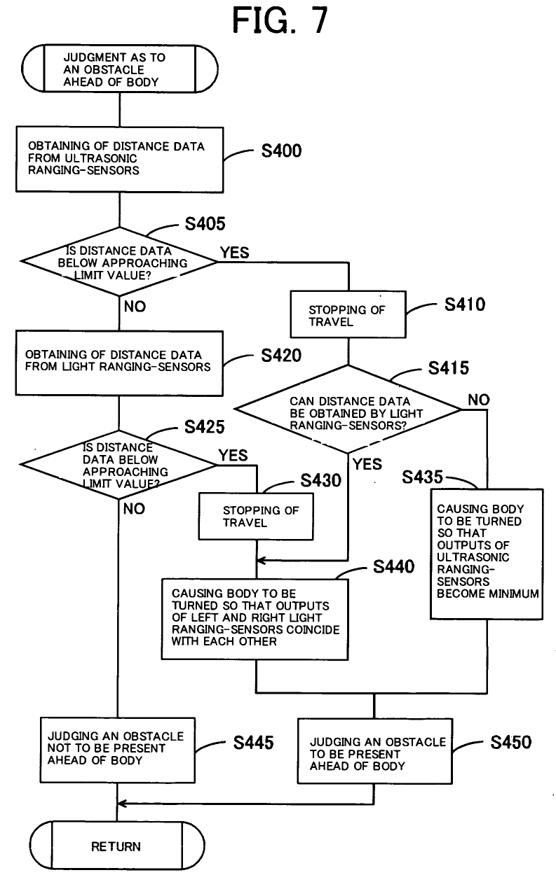

Moreover, the CPU 21 is adapted to carry out programs according to flow charts of FIGS. 4 and 7 and adapted to control the driving mechanism and the cleaner mechanism. Thus, the self-propelled cleaner can carry out the cleaning while being self-propelled. In this sense, the CPU 21, the RAM 22, the ROM 23 and the like constitute the control section.

(3) The operation of the self-propelled cleaner:

Now, the cleaning operation performed by the self-propelled cleaner 10 according to the present invention will be discussed hereinafter.

The self-propelled cleaner 10 according to the present invention recognizes information on locations of the body BD while causing the body BD to be traveled in the interior of the room or the like and causing the cleaner mechanism to perform the cleaning of the interior of the room or the like, and carries out a mapping operation in which cleaned areas of the room interior are mapped as cleaning-completed areas, areas of the room interior that are not yet cleaned are mapped as uncleaned areas, and areas of the room interior in which obstacles are present are mapped as obstacle areas. FIG. 4 is a flow chart exhibiting a procedure for the mapping operation performed by the self-propelled cleaner 10 according to the present invention.

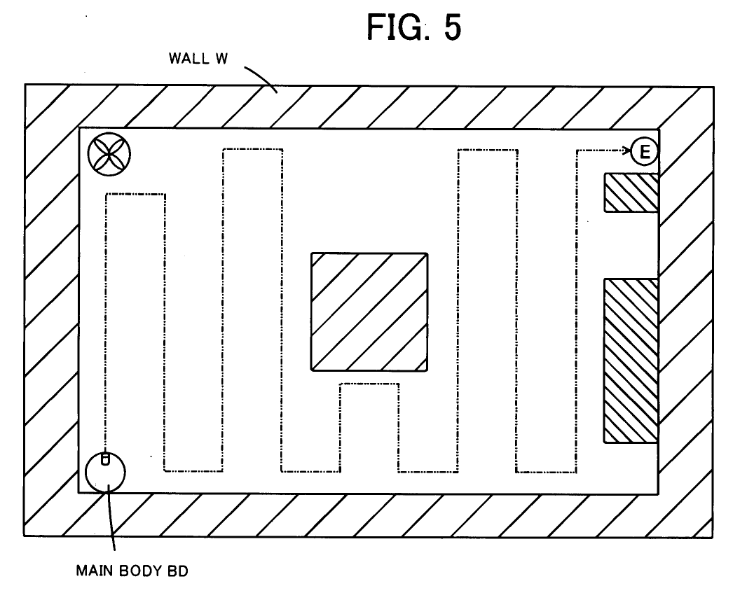

When the body BD is straightly advanced and arrives at a location that is short of an obstacle ahead of the body BD, the body BD is turned 90 degrees so as not to collide against the obstacle, and traveled by a predetermined distance (avoidance of collision against the obstacle). Thereafter, the body BD is again turned 90 degrees in the same direction, and again advanced straightly until the body BD arrives at the location that is short of the obstacle. Then, the direction of the 90° turn of the body BD is changed to a left direction, a right direction, or the left direction each time the body BD arrives at locations that are short of obstacles. Thus, the body BD is traveled in such a zigzag manner as shown in FIG. 5. Of course, the direction of the 90° turn of the body BD is determined in such a manner as will be discussed hereinafter.

When the mapping operation is carried out and the body BD is traveled to a terminal point, the body BD is moved to one of several uncleaned areas subjected to the mapping operation, which is an uncleaned area generally close to the place at which the body BD is present, and cleaning of the uncleaned area is then carried out. Such an uncleaned area-cleaning operation is continued until the uncleaned areas of the room interior are all cleaned.

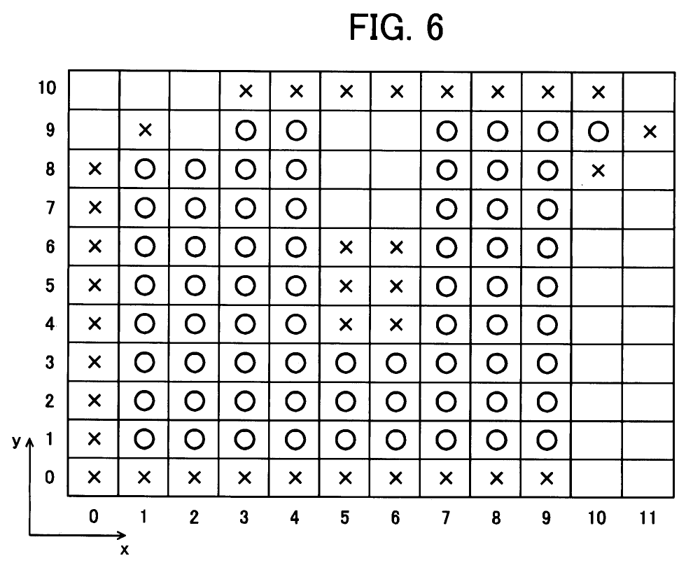

The procedure for the mapping operation that is exhibited in FIG. 4 will be discussed in conjunction with an operation for cleaning the room interior shown in FIG. 5. FIG. 6 illustrates one example of mapping data memorized in the RAM 22 (FIG. 3) when the mapping operation is carried out. A cleaning range of the self-propelled cleaner 10 at the time when the body BD is stopped is approximately equal to a dimension of the body BD (30 cm×30 cm). In the mapping operation, this range is set as a unit area, a vertical direction in the room interior (a vertical direction in FIG. 5) is denoted as an X coordinate axis, and a lateral direction in the room interior is denoted as a Y coordinate axis. Coordinates of respective unit areas for the cleaned areas, the uncleaned areas and the obstacle areas are in turn written into the RAM 22 or the like. For example, coordinates for the body BD shown in FIG. 5 are (1, 1), coordinates for a left-hand wall W are (0, m), and coordinates for a lower wall are (n, 0).

When the mapping operation is initiated, first of all, mapping of cleaned areas is carried out at a step S100. In this process, coordinates of a unit area for a place at which the body BD has been present are written into as a cleaning-completed area. For example, the coordinates (1, 1) for the body BD shown in FIG. 5 are written in as the cleaning-completed area. In FIG. 6, the coordinates (1, 1) are written in as the cleaning-completed area (shown with a mark “□”).

Then, a judgment is made at a step S110 as to whether or not any obstacle has been present on the left-hand of the body BD. In this process, a judgment is made as to whether or not the obstacle present on the left side has been detected by the left sidewall sensor 36L. In a case where it is judged at the step S110 that the left obstacle is present, a mapping operation is carried out with respect to an obstacle area at a step S120. That is, a unit area defined by coordinates at the left side of coordinates corresponding to a place at which the body BD has been present is written in as an obstacle area. In FIG. 6, a unit area defined by coordinates (0, 1) at the left side of the coordinates (1, 1) is written in as the obstacle area (shown with a mark “x”). Thus, mapping data are prepared by successively writing unit areas.

On the other hand, when it is judged at the step S110 that no obstacle has been present on the left side of the body BD, a mapping operation with respect to an uncleaned area is carried out. That is, a unit area defined by the coordinates at the left side of the coordinates corresponding to the place at which the body BD has been present is written as the uncleaned area. In FIG. 6, the uncleaned area is not indicated by any designator (remains blank). Incidentally, even if this area is once written in as the uncleaned area at the step S130, when the self-propelled cleaner travels and cleans an area of the room interior which corresponds to the unit area, the unit area is overwritten as a cleaning-completed area.

When the process at the step S120 or S130 is carried out, a judgment is then made at a step S140 as to whether or not any obstacle has been present on the right side of the body BD. In this process, a judgment is made as to whether or not the right sidewall sensor 36R has detected an obstacle on the right side of the body BD. When it is judged at the step S140 that any obstacle has been present on the right side of the body BD, an operation for mapping an area on the right side of the body BD as an obstacle area is carried out at a step S150. That is, a unit area defined by coordinates on the right side of the coordinates corresponding to the place at which the body BD has been present is written in as an obstacle area.

On the other hand, when it is judged at the step S140 that any obstacle has not been present on the right side of the body BD, an operation for mapping an area on the right side of the body BD as an uncleaned area is carried out at a step S160. That is, a unit area defined by the coordinates on the right side of the coordinates corresponding to the place at which the body BD has been present is written in as an uncleaned area.

When the process at the step S150 or S160 is carried out, a judgment is then made at a step S170 as to whether or not there is any obstacle ahead of the body BD.

FIG. 7 is a flow chart exhibiting a procedure for judgment made as to whether or not there is any obstacle ahead of the body BD.

At a step S400, ranging data is obtained from the ultrasonic ranging-sensor 31. Concretely, the CPU 21 obtains the ranging data from the ultrasonic ranging-sensor 31 through the sensor I/F 30. If the obstacle ahead of the body BD is an obstacle that can reflect supersonic waves emitted from the ultrasonic ranging-sensor, the ultrasonic ranging-sensors 31R, 31L can exactly range. At a step S405, the CPU 21 makes a judgment as to whether or not the obtained ranging-data is below an approaching limit value. In the illustrated example, the approaching limit value is set to 3 cm. When it is judged at the step S405 that the obtained ranging-data has been lower than the approaching limit, the traveling of the body BD is stopped at a step S410.

On the other hand, when it is not judged at the step S405 that the obtained ranging data is below the approaching limit value, ranging data from the left and right light ranging-sensors 32R, 32L is obtained at a step S420. Concretely, the CPU 21 obtains the ranging data from the light ranging-sensors 32R, 32L through the sensor I/F 30. When the obstacle ahead of the body BD is an obstacle which can reflect supersonic waves emitted from the ultrasonic ranging-sensor, the ultrasonic ranging-sensors 31R, 31L can precisely range. However, when the obstacle is a soft obstacle such as cloth and the like, the soft obstacle may absorb the supersonic waves and rarely reflect the supersonic waves. Therefore, it is difficult for the ultrasonic ranging-sensor 31 to deal with such an obstacle. However, even if the obstacle is the soft object, as far as it is an object other than, in particular, an object having dark color, the light ranging-sensors 32R, 32L can precisely range. Even if it is not judged at the step S405 that the ranging data from the ultrasonic ranging-sensor 31 is not below the approaching limit value, ranging data from the light ranging-sensors 32R, 32L is obtained at the step S420 and a judgment is made at a step S425 as to whether or not the ranging data from the light ranging-sensors is below the approaching limit value. Even in the case where the light ranging-sensors are used, the approaching limit is set to 3 cm. In a case where it is judged at the step S425 that the ranging data obtained from the light ranging-sensors is below the approaching limit value, the traveling of the body BD is stopped at a step S430.

Thus, the utilization of both the ultrasonic ranging-sensor 31 and the light ranging-sensors 32R, 32L makes it possible to precisely measure distances between the body and targets even if the targets are targets which have tendencies to prevent the distances between the body and the targets from being precisely measured by the ultrasonic ranging-sensor 31 only. Therefore, the utilization of both the ultrasonic ranging-sensors 31R, 31L and the light ranging-sensor 31 increases the number of targets whose distances from the body can be precisely measured, and enables the body not to collide against any obstacles.

In the illustrated example, in addition to precise detection of any obstacle, a correction of the travel angle is made in such a manner that the body BD becomes perpendicular to the obstacle, when the obstacle is detected by utilizing either of the ultrasonic ranging-sensor 31 and the light ranging-sensors 32R, 32L used jointly. Of course, obstacles which are to be generally detected are the walls of the room interior. When the body is repeatedly turned through 90° and traveled in the zigzag manner in the room interior as shown in FIG. 5 in order that the floor surface of the room interior can be cleaned throughout, the travel angle of the body becomes a problem. Even if the body is precisely traveled at the start, a subtle deviation of the body from the travel direction will be produced during the traveling of the body. If the subtle deviation is produced, areas of the floor will remain not to be subjected to the traveling of the body and remain uncleaned. In order to prevent such a situation, it is advantageous to correct the travel angle of the body each time the body faces the walls of the room interior during the traveling of the body.

To allow the body BD to become perpendicular to a wall of the room interior can be realized by causing the light ranging-sensors 32R, 32L arranged at the left and right of the front of the body BD to measure distances between the light ranging-sensors 32R, 32L and the wall and then causing the body BD to be turned in such a manner that data on the distances measured by the light ranging-sensors 32R, 32L coincide with each other, or causing the ultrasonic ranging-sensor 31 to measure a distance between the ultrasonic ranging-sensor 31 and the wall and then causing the body BD to be turned in such a manner that data on the distance measured by the ultrasonic ranging-sensor 31 becomes minimum.

While the former manner is preferable, to distinguish between the employment of the former manner and the employment of the latter manner is performed, depending upon situations.

In the illustrated embodiment, a judgment is made at a step S415 as to whether or not the light ranging-sensors 32R, 32L can obtain distance data, and distinguishing between the employment of the former manner and the employment of the latter manner is carried out according to a result of the judgment. That is, if the light ranging-sensors 32R, 32L can obtained the distance data, it is preferable to use the distance data, so that the distance data is used at a step S440 and the body BD is turned in such a manner that the distance data obtained by the right and left light ranging-sensors 32R, 32L coincide with each other. Moreover, unless the light ranging-sensors 32R, 32L can obtain the distance data, it is impossible to use the distance data and the body BD is turned at a step S435 in such a manner that the distance data obtained by the ultrasonic ranging-sensor 31 becomes minimum.

Incidentally, as shown in the flow-chart of FIG. 7, if it is judged, at the step S420, from the distance data obtained by the light ranging-sensors 32R, 32L that the body BD is situated at a location which is below the approaching limit value, it is unnecessary to again make a judgment as to whether or not the light ranging-sensors 32R, 32L can obtain distance data, the travel of the body BD is stopped at the step S430 and, thereafter, the body BD is turned at the step S440. Only when it is judged, at the step S405, from the distance data obtained by the ultrasonic ranging-sensors 31 that the body BD is situated at the location which is below the approaching limit value, a judgment is made as to whether or not the light ranging-sensors 32R, 32L can obtain distance data.

Unless it is judged that the distance data obtained by both the ultrasonic ranging-sensor 31 and the light ranging-sensors 32R, 32L shows that the body BD is brought into an approaching limit condition, it is judged at a step S445 that there is no obstacle ahead of the body BD. If it is judged from the distance data obtained by either of the ultrasonic ranging-sensor 31 and the light ranging-sensors 32L, 32R that the body BD is brought into the approaching limit condition, it is judged at a step S450 that there is an obstacle ahead of the body BD. The judgment results are to be used in the judgment made at the step S170 shown in FIG. 4.

Incidentally, the judgment made at the step S170 as to whether or not there is the obstacle ahead of the body BD corresponds to a judgment as to whether or not there is an obstacle in a unit area defined in front of and next to coordinates at which the body BD is considered to have existed at the present time in the mapping operation. For example, when the body BD is considered to have been situated at a unit area defined by coordinates (1, 8) in FIG. 6, a judgment is made as to whether or not there is an obstacle in a unit area defined by coordinates (1, 9) in front of and next to the coordinates (1, 8).

If it is judged at the step S170 that the obstacle ahead of the body BD has been detected, a process for mapping an obstacle area is carried out at a step S180. That is, a process for writing, as the obstacle area, the coordinates in front of and next to the unit area at which the body BD is considered to have situated at the present time is carried out. For example, the unit area defined by the coordinates (1, 9) in front of and next to the unit area defined by the coordinates (1, 8), at which the body BD is considered to have existed, is written into as the obstacle area (shown with a mark “X”) as shown in FIG. 6.

After the process at the step S180 is completed, a process for causing the body BD to be turned through 90° is carried out. When this process is performed, the body BD is traveled in parallel with the obstacle.

Direction of the 90° turn of the body at this time is a direction in which no obstacle is present and an uncleaned area is present.

When a process at a step S190 is performed or it is judged at the step S170 that there is no obstacle ahead of the body BD, a process for causing the body BD to be advanced is then performed at a step S200. In this process, controlling of the drive motors 42R, 42L is performed and causing the body BD to be straightly advanced by a distance corresponding to a unit area is performed. For example, when the body BD is considered to have been situated in the unit area defined by the coordinates (1, 1), the body BD is traveled to a unit area defined by coordinates (1, 2). Also, for example, when the body BD is considered to have been situated in the unit area defined by the coordinates (1, 8) and the 90° tum of the body BD is performed at the step S190, the body BD is moved to a unit area defined by coordinates (2, 9).

When the process at the step S200 is performed, a judgment is then made as to whether or not the body BD is already turned 90 degrees. In this process, prior to performing of the process for causing the body BD to be advanced at the step S200, a judgment is made as to whether or not the 90° turn of the body BD has been carried out by the process of the step S190. When it is judged at the step S210 that the 90° turn of the body BD has been already performed, the body BD is again turned through 90° at a step S220.

On the other hand, when it is judged at the step S210 that the 90° turn of the body BD is not yet performed, a judgment is then made at a step S230 as to whether or not the body BD has arrived at the terminal. In the mapping operation, in cases where obstacles ahead of the body BD and at the left and right of the body BD are detected and the body BD is arrived at unit areas which the body BD already traveled, it is judged that the body BD has arrived at the terminal. When it is judged at the step S230 that the body BD does not yet arrive at the terminal, the process is returned to the step S100. On the other hand, when it is judged at the step S230 that the body BD has arrived at the terminal, the mapping operation is terminated.

By performing the mapping process shown in FIG. 4, the body BD is traveled along a path indicated in FIG. 5 by a chain double-dashed line. When the body BD arrives at an E point (coordinates (10, 9)) shown in FIG. 5, the process is terminated at the E point and the body BD is stopped. Thus, such a mapping data as shown in FIG. 6 is prepared. Incidentally, blank areas in FIG. 6 indicate uncleaned areas as discussed above but they include areas in which the body BD can be actually traveled and areas in which any obstacles are present and the body BD can not be traveled.

After the mapping process shown in FIG. 4 is performed, the body BD is moved to the uncleaned areas corresponding to the blank areas shown in FIG. 6, the body BD is traveled the uncleaned areas and a process for cleaning of the uncleaned areas is continued.

(4) Various variants

While the drive mechanism comprises a pair of the drive motors 42R, 42L and a pair of the drive wheels 12R, 12L in the illustrated embodiment, a different drive mechanism including, for example, endless belts may be employed. Moreover, the cleaner mechanism comprises the side brushes, the main brush and the suction fan, and can facilitate most efficient cleaning. However, usable resources have their limits, so that when there has a demand for a reduction in the number of the motors, and the like, the number of the side brushes may be reduced. Moreover, a cleaner mechanism in which the suction fan is omitted may be employed.

While the movement-detecting sensor comprises the rotary encoders 43R, 43L which are connected to the drive motors 42R, 42L, the rotary encoders may be connected to the driven wheels, whereby precise movement-information can be obtained even if the drive wheels 12R, 12L are slipped. Of course, a detection result which is obtained by another sensor such as the gyro sensor can be also utilized.

While a peripheral sensor of the self-propelled cleaner according to the embodiment of the present invention comprises the ultrasonic ranging-sensor 31, the light ranging-sensors 32R, 32L, and the side wall sensors 36, different sensors which utilize other various principles may be employed in order to detect conditions around the body BD.

Moreover, the mapping operation may be performed in various manner and, in addition to the causing of the body to be traveled throughout the floor surface of the room interior in the zigzag manner on the basis of the 90° turn of the body BD and the straight advancing of the body BD, various control manners may be employed.

(5) Summary

As discussed above, in the self-propelled cleaner 10 which is an exemplary embodiment of the travel device, after the measured distance data is obtained from the ultrasonic ranging-sensor 31 at the step S400, the judgment is made at the step S405 as to whether or not the obtained distance data is below the approaching limit value. When it is judged that the data is below the approaching limit value, the travel of the body BD is stopped at the step S410. On the other hand, when it is judged at the step S405 that the data is not below the approaching limit value, the distance data are obtained from the left and right light ranging-sensors 32R, 32L at the step S420 and the judgment is then made at the step S425 as to whether or not the data obtained from the light ranging-sensors are below the approaching limit value. When it is judged that the data obtained by either of the ultrasonic ranging-sensors and the light ranging-sensors are below the approaching limit value, the travel of the body is stopped. Therefore, even if any targets can not be subjected to precise measurement of distances from the body to the targets by the ultrasonic ranging-sensor 31 only, it is possible to increase the number of targets capable of being subjected to the precise measurement of the distances by simultaneously using the light ranging-sensors 32R, 32L. Thus, the body BD can be controlled so as not to collide against any obstacles.

Further, even though one of embodiments of the travel device is a self-propelled cleaner, the travel device could be adopted for another traveling devices with a numerous variation of purposes such as security purpose travel device to move in the room interior to detect security obstacles.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

What is claimed is:

1. A travel device comprising:
a body having a substantially cylindrical shape that is short in length;
a driving mechanism for causing the body to be traveled in a predetermined direction;
a movement-detecting sensor for detecting information on the movement of the body;
a peripheral sensor for detecting circumstances around the body;
an operation panel arranged at an outer surface of the body; and
a control section for receiving detection results obtained by the movement-detecting sensor and the peripheral sensor, and an operation input from the operation panel, controlling the driving mechanism according to predetermined control programs memorized in advance, causing the body to be traveled on a floor surface of a predetermined range;
the driving mechanism comprising:
left and right drive wheels arranged at portions of a bottom of the body which are adjacent to both sides of the bottom of the body;
drive motors adapted to be rotated in a normal direction or a reverse direction independently from each other,
the left and right drive wheels being adapted to be driven by the drive motors; and
a freely rollable wheel provided at a forward portion of the bottom of the body;
the movement-detecting sensor being adapted to detect rotation amounts and rotational directions of the left and right drive wheels;
the peripheral sensor comprising:
light ranging-sensors arranged at the left and right of a front side of the body;
an ultrasonic ranging-sensor arranged at a substantially central portion of the front side of the body; and
sidewall sensors arranged at the left and right of the body;
the control section being adapted to carry out a mapping operation with respect to a room interior or the like on the basis of a dimension of the body, while causing the body to be traveled a predetermined range of the room interior by the driving mechanism, recognize information on locations of the body in the room interior, according to operation instructions from the operation panel;
the control section being adapted to cause the sidewall sensors to detect any obstacles on sides of the body and cause the ultrasonic ranging-sensor to detect any obstacle ahead of the body, while causing the body to be traveled, when the mapping operation is carried out;
the control section being adapted to control the driving mechanism in such a manner that the driving mechanism does not allow the body to collide against the obstacles and keeps the body away from the obstacles when the obstacles are detected;
the control section being adapted to cause the light ranging-sensors to detect the obstacle ahead of the body when the ultrasonic ranging-sensor do not detect the obstacle ahead of the body;
the control section being adapted to control the driving mechanism in such a manner that the driving mechanism does not allow the body to collide against the obstacle ahead of the body and keeps the body away from the obstacle ahead of the body when the obstacle ahead of the body is detected by the light ranging-sensors;
the control section being adapted to control the driving mechanism in such a manner that the driving mechanism corrects a travel angle of the body so as to cause the body become perpendicular to the obstacle ahead of the body, when the obstacle ahead of the body is detected by the light ranging-sensors, on the basis of detection results of the light ranging-sensors if the detection results are obtained, or detection results of the ultrasonic ranging-sensor unless the detection results of the light ranging-sensors are obtained; and
the control section being adapted to cause detection results of the peripheral sensor and information on the movement of the body to be reflected in mapping data.

2. A travel device comprising:
a body;
a driving mechanism for causing the body to be traveled in a predetermined direction;
a movement-detecting sensor for detecting information on the movement of the body;
a peripheral sensor for detecting circumstances around the body;
an operation panel arranged at an outer surface of the body; and
a control section for receiving detection results obtained by the movement-detecting sensor and the peripheral sensor, and an operation input from the operation panel, controlling the driving mechanism according to predetermined control programs memorized in advance, causing the body to be traveled on a floor surface of a predetermined range;
the peripheral sensor comprising:
light ranging-sensors arranged at a front side of the body;
an ultrasonic ranging-sensor arranged at the front side of the body; and
sidewall sensors arranged at the left and right of the body;
the control section being adapted to carry out a mapping operation with respect to a room interior or the like on the basis of a dimension of the body, while causing the body to be traveled a predetermined range of the room interior by the driving mechanism, recognize information on locations of the body in the room interior, according to operation instructions from the operation panel;
the control section being adapted to cause the sidewall sensors to detect any obstacles on sides of the body and cause both the ultrasonic ranging-sensor and the light ranging-sensors to detect any obstacle ahead of the body, while causing the body to be traveled by the driving mechanism, when the mapping operation is carried out;
the control section being adapted to control the driving mechanism in such a manner that the driving mechanism does not allow the body to collide against the obstacles and keeps the body away from the obstacles when the obstacles are detected; and
the control section being adapted to cause detection results of the peripheral sensor and information on the movement of the body to be reflected in mapping data.

3. A travel device according to claim 2, wherein the control section is adapt to cause the ultrasonic ranging-sensor to detect the obstacle ahead of the body, while causing the body to be traveled, adapted to control the driving mechanism in such a manner that the driving mechanism does not allow the body to collide against the obstacle ahead of the body and keeps the body away from the obstacles ahead of the body when the obstacle is detected by the ultrasonic ranging-sensor, adapted to cause the light ranging-sensors to detect the obstacle ahead of the body when the obstacle ahead of the body is not detected by the ultrasonic ranging-sensor, and adapted to control the driving mechanism in such a manner that the driving mechanism does not allow the body to collide against the obstacle ahead of the body and keeps the body away from the obstacle ahead of the body when the obstacle ahead of the body is detected by the light ranging-sensors.

4. A travel device according to claim 2, wherein the light ranging-sensors are arranged at the left and right of the front side of the body, and the ultrasonic ranging-sensor is arranged at a substantially central portion of the front side of the body.

5. A travel device according to claim 4, wherein the control section is adapted to control the driving mechanism in such a manner that the driving mechanism causes the body to be turned in such a manner to allow detection results of the light ranging-sensors to coincide with each other, causes a travel angle of the body to be changed, and corrects the travel angle of the body in such a manner that the body becomes perpendicular to the obstacle ahead of the body, when the obstacle ahead of the body is detected and the detection results of the light ranging-sensors are obtained.

6. A travel device according to claim 5, wherein the control section is adapted to control the driving mechanism in such a manner that the driving mechanism causes the travel angle of the body to be changed in such a manner that the detection results of the ultrasonic ranging-sensor become minimum, while causing the body to be turned, whereby the travel angle of the body is corrected in such a manner that the body becomes perpendicular to the obstacle ahead of the body, when the obstacle ahead of the body is detected and the detection results of the light ranging-sensors are not obtained.

7. A travel device according to claim 5, wherein the control section is adapted to make a judgment as to whether or not the detection results can be obtained by the light ranging-sensors, when the obstacle ahead of the body is detected by the ultrasonic ranging-sensor, and adapted to control the driving mechanism in such a manner that the travel angle of the body is corrected utilizing the detection results, without causing the detection to be again performed, when the obstacle ahead of the body is detected by the light ranging-sensors.

8. A travel device according to claim 4, wherein the control section is adapted to control the driving mechanism in such a manner that the driving mechanism causes the body to be stopped and the travel angle is corrected in such a manner to allow the body to become perpendicular to the obstacle ahead of the body, when a distance between the body and the obstacle ahead of the body is a predetermined distance.
